(19) United States
(12) Patent Application Publication
(10) Pub. No.: US 2026/0230992 A1
(43) Pub. Date: Aug. 6, 2026

(54) HANDLING OF CONDITIONAL MOBILITY TIMING IN WIRELESS COMMUNICATIONS

(71) Applicant: LG ELECTRONICS INC., Seoul (KR)

(72) Inventors: Sunghoon JUNG, Seoul (KR); Hongsuk KIM, Seoul (KR)

(73) Assignee: LG ELECTRONICS INC., Seoul (KR)

(21) Appl. No.: 19/159,590

(22) PCT Filed: Mar. 8, 2024
(86) PCT No.: PCT/KR2024/003019

§ 371 Date: Aug. 25, 2025

Related U.S. Application Data
(60) Provisional application No. 63/450,672, filed on Mar. 8, 2023.

(51) Int. Cl. H04W 36/36; H04W 36/00

(52) U.S. Cl. CPC H04W 36/362; H04W 36/0072

(57) ABSTRACT

The present disclosure is related to handling of conditional mobility timing in wireless communications. According to an embodiment of the present disclosure, a user equipment (UE) may evaluate an execution condition for the CHO and an execution condition for a conditional primary secondary cell (PSCell) mobility, and delay performing a conditional handover (CHO) for a time period when the execution condition for the CHO is met while the execution condition for the conditional PSCell mobility is not met.

### CROSS-REFERENCE TO RELATED APPLICATION(S)

This application is the National Stage filing under 35 U.S.C. 371 of International Application No. PCT/KR2024/003019, filed on Mar. 8, 2024, which claims the benefit of U.S. Provisional Application No. 63/450,672, filed on Mar. 8, 2023, the contents of which are all incorporated by reference herein in their entirety.

### TECHNICAL FIELD

The present disclosure is related to handling of conditional mobility timing in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a user equipment (UE) may perform a conditional mobility where a network configures the UE with a plurality of candidate cells, and the UE determines a target cell which satisfies a mobility execution condition among the plurality of candidate cells. When evaluating multiple execution conditions, a conditional mobility timing may be an issue.

### SUMMARY

An aspect of the present disclosure is to provide method and apparatus for handling of conditional mobility timing in a wireless communication system.

According to an embodiment of the present disclosure, a method performed by a user equipment (UE) configured to operate in a wireless communication system comprises: receiving, from a network, a configuration for a conditional handover (CHO) to a target primary cell (PCell), wherein the configuration for the CHO comprises an execution condition for the CHO, and an execution condition for a conditional primary secondary cell (PSCell) mobility to a first target PSCell, and wherein the configuration for the CHO is related to a configuration for the conditional PSCell mobility; evaluating the execution condition for the CHO while evaluating the execution condition for the conditional PSCell mobility; after the execution condition for the CHO is met while the execution condition for the conditional PSCell mobility is not met, delaying performing the CHO for a time period; and based on the execution condition for the conditional PSCell mobility being not met during the time period, performing the CHO to the target PCell.

According to an embodiment of the present disclosure, a method performed by a network node configured to operate in a wireless communication system comprises: obtaining a configuration for a conditional handover (CHO) to a target primary cell (PCell), wherein the configuration for the CHO comprises an execution condition for the CHO, and an execution condition for a conditional primary secondary cell (PSCell) mobility to a first target PSCell, and wherein the configuration for the CHO is related to a configuration for the conditional PSCell mobility; and transmitting, to a user equipment (UE), the configuration for the CHO to the target PCell, wherein the UE is configured to perform operations comprising: evaluating the execution condition for the CHO while evaluating the execution condition for the conditional PSCell mobility; after the execution condition for the CHO is met while the execution condition for the conditional PSCell mobility is not met, delaying performing the CHO for a time period; and based on the execution condition for the conditional PSCell mobility being not met during the time period, performing the CHO to the target PCell.

According to various embodiments, apparatuses implementing the above methods are provided.

The present disclosure may have various advantageous effects.

For example, unnecessary signaling and/or interruption can be prevented when executing a conditional mobility based on simultaneous evaluation of conditional handover (CHO) condition and conditional primary secondary cell (PSCell) mobility condition.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a dual connectivity (DC) architecture to which technical features of the present disclosure can be applied.

FIG. 9 shows an example of a conditional mobility procedure according to an embodiment of the present disclosure.

FIG. 10 shows an example of a method performed by a UE according to an embodiment of the present disclosure.

FIG. 11 shows an example of a signal flow between a UE and a network node according to an embodiment of the present disclosure.

FIG. 12 shows a first example of a method for CHO with concurrent early CPC according to an embodiment of the present disclosure.

FIG. 13 shows an example of an evaluation status of a CPC execution condition according to an embodiment of the present disclosure.

FIG. 14 shows an example of a timer-based CPC condition evaluation according to an embodiment of the present disclosure.

FIG. 15 shows a second example of a method for CHO with concurrent early CPC according to an embodiment of the present disclosure.

FIG. 16 shows an example of a method for CHO with concurrent early CPA according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system. CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

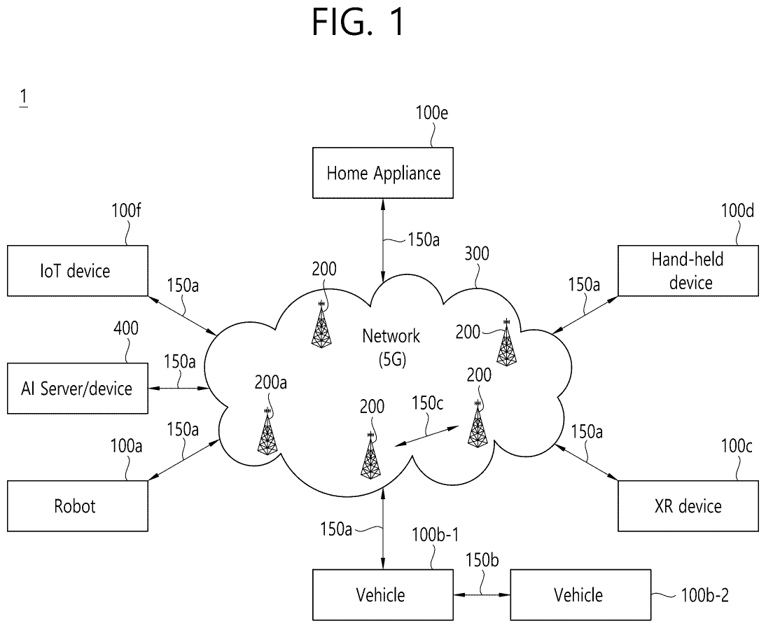

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an extended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | Subcarrier | |
|---|---|---|---|
| designation | frequency range | Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | Subcarrier | |
|---|---|---|---|
| designation | frequency range | Spacing | |
| FR1 | 410 MHz-7125 MHz | 15, 30, 60 | kHz |
| FR2 | 24250 MHz-52600 MHz | 60, 120, 240 | kHz |

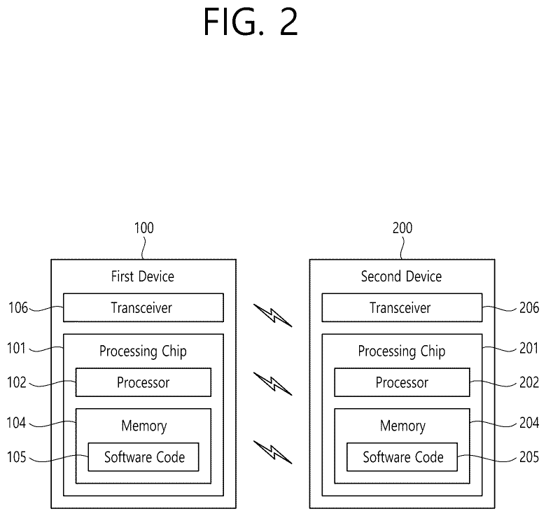

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

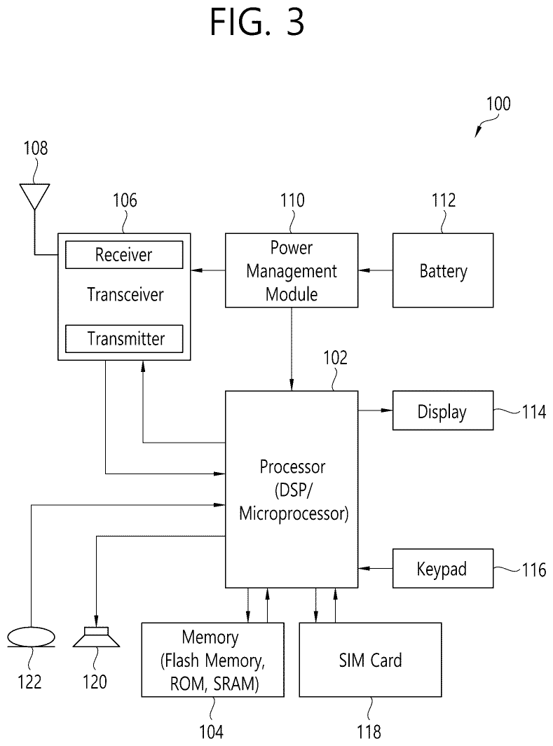

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

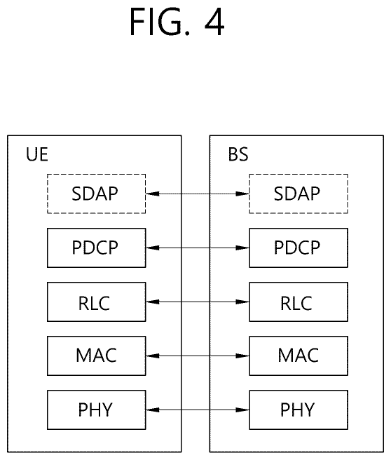

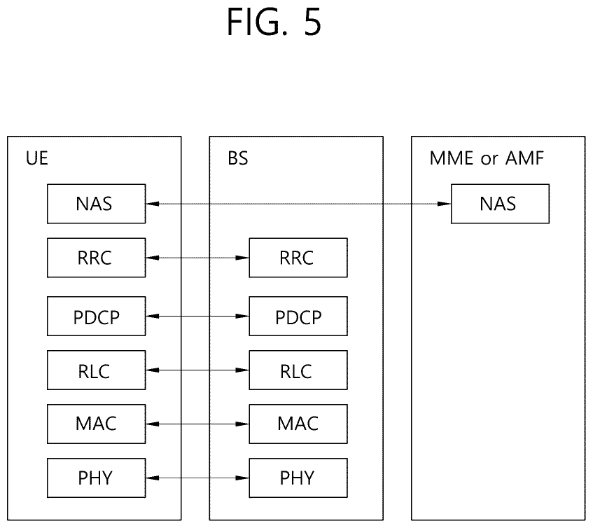

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (L1, for example PHY layer) and Layer 2 (L2, for example MAC/RLC/PDCP layer). Referring to FIG. 5, the control plane protocol stack may be divided into Layer 1 (L1, for example PHY layer), Layer 2 (L2, for example MAC/RLC/PDCP layer), Layer 3 (L3, for example an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

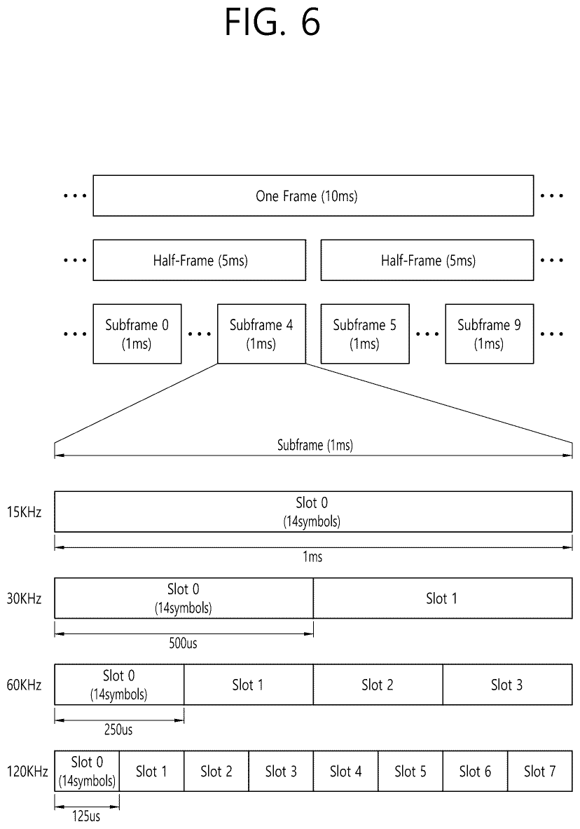

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 KHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing βf=2*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) start, u grid indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. As shown in FIG. 6, as SCS doubles, the slot length and symbol length are halved. For example, when SCS is 15 kHz, the slot length is 1 ms, which is the same as the subframe length. When SCS is 30 kHz, the slot length is 0.5 ms (=500 us), and the symbol length is half of that when the SCS is 15 kHz. When SCS is 60 kHz, the slot length is 0.25 ms (=250 us), and the symbol length is half of that when the SCS is 30 kHz. When SCS is 120 kHz, the slot length is 0.125 ms (=125 us), and the symbol length is half of that when the SCS is 60 kHz. When SCS is 240 kHz, the slot length is 0.0625 ms (=62.5 us), and the symbol length is half of that when the SCS is 120 kHz.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

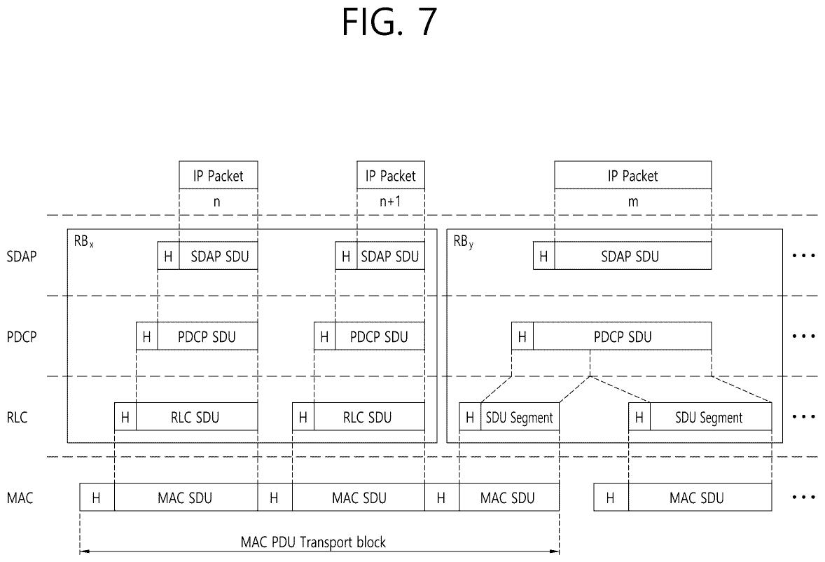

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and random access channel (RACH) are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

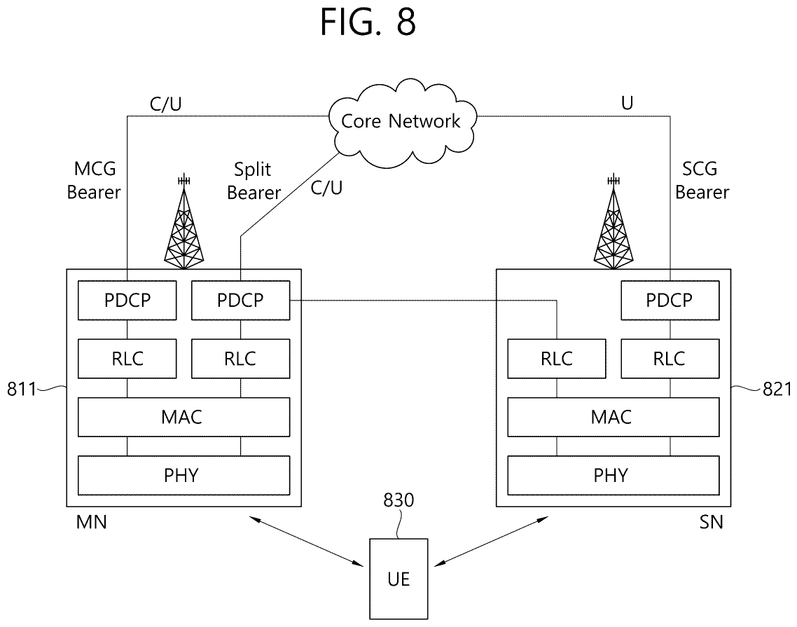

FIG. 8 shows an example of a dual connectivity (DC) architecture to which technical features of the present disclosure can be applied.

Referring to FIG. 8, MN 811, SN 821, and a UE 830 communicating with both the MN 811 and the SN 821 are illustrated. As illustrated in FIG. 8, DC refers to a scheme in which a UE (e.g., UE 830) utilizes radio resources provided by at least two RAN nodes comprising a MN (e.g., MN 811) and one or more SNs (e.g., SN 821). In other words, DC refers to a scheme in which a UE is connected to both the MN and the one or more SNs, and communicates with both the MN and the one or more SNs. Since the MN and the SN may be in different sites, a backhaul between the MN and the SN may be construed as non-ideal backhaul (e.g., relatively large delay between nodes).

MN (e.g., MN 811) refers to a main RAN node providing services to a UE in DC situation. SN (e.g., SN 821) refers to an additional RAN node providing services to the UE with the MN in the DC situation. If one RAN node provides services to a UE, the RAN node may be a MN. SN can exist if MN exists.

For example, the MN may be associated with macro cell whose coverage is relatively larger than that of a small cell. However, the MN does not have to be associated with macro cell—that is, the MN may be associated with a small cell. Throughout the disclosure, a RAN node that is associated with a macro cell may be referred to as ‘macro cell node’. MN may comprise macro cell node.

For example, the SN may be associated with small cell (e.g., micro cell, pico cell, femto cell) whose coverage is relatively smaller than that of a macro cell. However, the SN does not have to be associated with small cell—that is, the SN may be associated with a macro cell. Throughout the disclosure, a RAN node that is associated with a small cell may be referred to as ‘small cell node’. SN may comprise small cell node.

The MN may be associated with a master cell group (MCG). MCG may refer to a group of serving cells associated with the MN, and may comprise a primary cell (PCell) and optionally one or more secondary cells (SCells). User plane data and/or control plane data may be transported from a core network to the MN through a MCG bearer. MCG bearer refers to a bearer whose radio protocols are located in the MN to use MN resources. As shown in FIG. 8, the radio protocols of the MCG bearer may comprise PDCP, RLC, MAC and/or PHY.

The SN may be associated with a secondary cell group (SCG). SCG may refer to a group of serving cells associated with the SN, and may comprise a primary secondary cell (PSCell) and optionally one or more SCells. User plane data may be transported from a core network to the SN through a SCG bearer. SCG bearer refers to a bearer whose radio protocols are located in the SN to use SN resources. As shown in FIG. 8, the radio protocols of the SCG bearer may comprise PDCP, RLC, MAC and PHY.

User plane data and/or control plane data may be transported from a core network to the MN and split up/duplicated in the MN, and at least part of the split/duplicated data may be forwarded to the SN through a split bearer. Split bearer refers to a bearer whose radio protocols are located in both the MN and the SN to use both MN resources and SN resources. As shown in FIG. 8, the radio protocols of the split bearer located in the MN may comprise PDCP, RLC, MAC and PHY. The radio protocols of the split bearer located in the SN may comprise RLC, MAC and PHY.

According to various embodiments, PDCP anchor/PDCP anchor point/PDCP anchor node refers to a RAN node comprising a PDCP entity which splits up and/or duplicates data and forwards at least part of the split/duplicated data over X2/Xn interface to another RAN node. In the example of FIG. 8, PDCP anchor node may be MN.

According to various embodiments, the MN for the UE may be changed. This may be referred to as handover, or a MN handover.

According to various embodiments, a SN may newly start providing radio resources to the UE, establishing a connection with the UE, and/or communicating with the UE (i.e., SN for the UE may be newly added). This may be referred to as a SN addition.

According to various embodiments, a SN for the UE may be changed while the MN for the UE is maintained. This may be referred to as a SN change.

According to various embodiments, DC may comprise E-UTRAN NR-DC (EN-DC), and/or multi-radio access technology (RAT)-DC (MR-DC). EN-DC refers to a DC situation in which a UE utilizes radio resources provided by E-UTRAN node and NR RAN node. MR-DC refers to a DC situation in which a UE utilizes radio resources provided by RAN nodes with different RATs.

Hereinafter, contents regarding mobility are described.

The mobility may comprise PCell change, PSCell change (or, secondary node (SN) change), and/or PSCell addition (or, SN addition).

There may be at least two types of mobility: network-controlled mobility (or, legacy mobility) and UE-based mobility (or, conditional mobility).

The network-controlled mobility (or, legacy mobility) is a mobility where the network determines a target cell for mobility, and configures UE with the target cell. The network may transmit, to the UE, an RRCReconfiguration message comprising a configuration for the target cell. The UE may execute a mobility to the target cell/apply the configuration for the target cell, upon receiving the cell configuration for the target cell.

The UE-based mobility (or, conditional mobility) is a mobility where the network configures the UE with a plurality of candidate cells, and the UE determines a target cell which satisfies a mobility execution condition among the plurality of candidate cells. The conditional mobility may comprise at least one of a conditional PCell change/conditional handover (CHO) or a conditional PSCell mobility. The conditional PSCell mobility may comprise conditional PSCell addition/change (CPAC), including conditional PSCell addition (CPA) and/or conditional PSCell change (CPC). The network may transmit, to the UE, an RRCReconfiguration message comprising ConditionalReconfiguration information element (IE), which comprises a list of conditional reconfigurations for the plurality of candidate cells. A conditional reconfiguration for a candidate cell may comprise an identifier of the conditional reconfiguration, a mobility execution condition for the candidate cell, and a configuration for the candidate cell. The UE may evaluate the mobility execution conditions for the plurality of candidate cells, and when a mobility execution condition for a candidate cell is satisfied, the UE may consider the candidate cell as a target cell, and execute a mobility to the target cell/apply the configuration for the target cell.

According to various embodiments, the mobility execution condition may be satisfied/met when an entry condition (or, entering condition) for the mobility execution condition is satisfied/met for at least a time-to-trigger (TTT) for the mobility execution condition. The entry condition/entering condition may mean that the mobility execution condition is initially met. Once the entry condition is met, the mobility execution condition will be considered to be met if the entry condition is met for time duration TTT continuously.

In the present disclosure, the term “handover (HO)” may mean PCell change, or may be a broad concept that includes not only PCell change but also PSCell change/addition.

In the present disclosure, the terms “handover”, “mobility” and “cell switch” can be used interchangeably.

In the present disclosure, the description regarding handover can also be applied to other mobility procedures (e.g., PSCell change/addition).

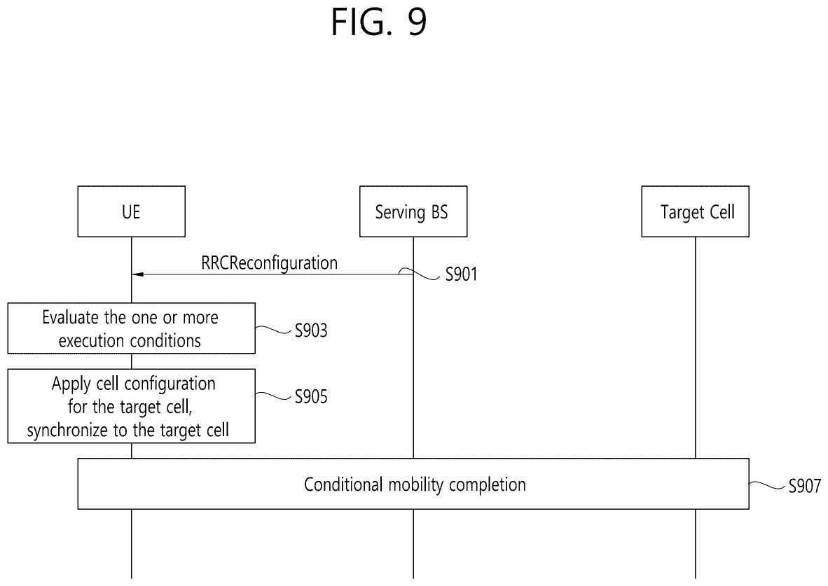

FIG. 9 shows an example of a conditional mobility procedure according to an embodiment of the present disclosure.

In FIG. 9:
the serving BS may be related to a PCell, which may be a source PCell for CHO;
the serving BS may be an MN associated with an SN in DC, where the SN may be related to a source PSCell for CPC; and
the target cell may be a target PCell for CHO, or a target PSCell for CPA/CPC.

Referring to FIG. 9, in step S901, UE may receive, from the serving BS, an RRCReconfiguraiton message comprising a conditional reconfiguration information element (IE) (i.e., CondidtionalReconfiguration). The conditional reconfiguration IE may comprise a list of conditional reconfigurations for candidate cells including the target cell. Each conditional reconfiguration in the list may be related to the corresponding candidate cell, and comprises i) an identifier of the corresponding conditional reconfiguration (i.e., condReconfigId), ii) one or more execution conditions for the corresponding candidate cell (i.e., condExecutionCond), and/or iii) RRC reconfiguration for the corresponding candidate cell (i.e., condRRCReconfig) including a cell configuration for the corresponding candidate cell. The one or more execution conditions may comprise CHO execution condition(s), CPA execution condition(s), and/or CPC execution condition(s).

In step S903, the UE may start evaluating the one or more execution conditions for the candidate cells. In FIG. 9, it is assumed that the target cell satisfies the corresponding execution condition(s).

In step S905, the UE may detach from the source PCell/PSCell (for a case of CHO/CPC), apply the RRC reconfiguration for the target cell including a cell configuration for the target cell, and/or synchronize to the target cell. The UE may skip a random access towards the target cell if timing advance (TA) information for the target cell is available—otherwise, the UE should perform a random access (e.g., contention-free random access (CFRA) and/or contention-based random access (CBRA)) towards the target cell.

In step S907, the UE may complete the conditional mobility procedure by sending RRCReconfiguraitonComplete message to the target cell.

In some implementations, the UE may release conditional reconfiguration(s) after successful completion of the conditional mobility procedure.

Hereinafter, simultaneous evaluation for CHO and CPAC is described.

In a wireless communication system, CHO including target MCG and target SCG may be supported, and CHO configuration referring to or including CPC/CPA configuration (intended to be applicable together) may be supported. When triggering CHO, UE may perform CPC/CPA configuration to start CPC/CPA evaluation. CHO evaluation and CPC/CPA evaluation may be concurrent or sequential.

As stated above, CHO with SCG configurations is already supported. However, the CHO with SCG configuration is still triggered under the normal CHO triggering conditions (e.g., CondEventA3, CondEventA5) that are based only on the target/source PCell's quality. The drawback of this is that the target SCG (PSCell) is added blindly without taking its quality (or/and the source PSCell) into consideration. Doing so may result in adding an SCG in bad radio conditions, and subsequent SCG failure, SCG failure recovery and reconfigurations.

Thus, a more optimal approach is to also consider the conditions of the target/source PSCell. That is:
A UE can be configured with a CHO and associated SCG and configured to consider triggering conditions on the source/target PCell and source/target PSCell; and/or
A UE will monitor both triggering conditions and execute the CHO with the associated SCG only if both triggering conditions are fulfilled.

In some scenarios, it could be possible that there can be several candidate PSCells for a certain PCell. This can be realized via implementation, where a CHO with associated SCG is configured for each possible PSCell. However, this is inefficient signalling, as the MCG configuration is repeated in each configuration. A more optimal solution is to have a CHO that can be configured/associated with multiple SCGs, each with its own triggering conditions. For example, a CHO can be associated with multiple SCGs, each having different triggering conditions.

For example, a UE may be configured with a CHO configuration that has two associated SCGs, SCG1 and SCG2. If the triggering conditions for the PCell and PSCell1 get fulfilled, the UE will execute the CHO with SCG1. If the triggering conditions for the PCell and PSCell2 get fulfilled, the UE will execute the CHO with SCG2. Releasing all conditional reconfigurations upon the execution of another conditional reconfiguration will result in unnecessary reconfigurations. Thus, it is proposed that, when a UE executes a CHO with multiple SCGs associated with it, it may be configured to keep the other SCG configurations associated with the SCG and keep monitoring their triggering conditions.

With regard to the RRC signalling structure design, there are two main possibilities:
a) A CHO containing the MCG configuration (and triggering conditions) and the associated SCG configuration(s) (and the SCG triggering conditions)
b) A CHO containing only the MCG configuration (and PCell change triggering condition), separate configuration for each SCG (i.e., a CPC with SCG configuration and PSCell change triggering condition), and a configuration associating the CHO with the SCG configuration(s) (e.g., in a way like a measurement ID associates a measurement object and a measurement reporting configuration).

That is, at least one of the following structures for defining CHO with associated SCG may be considered:
a) One CHO configuration containing all the MCG configuration, SCG configuration(s), and triggering conditions for the PCell change and PSCell change; and/or
b) Separate CHO and CPAC configuration(s), and a configuration associating the CHO and CPAC configuration(s).

According to various embodiments, the UE may receive a list of conditional reconfigurations (i.e., CondReconfigToAddModList IE) from a network. The IE CondReconfigToAddModList concerns a list of conditional reconfigurations to add or modify, with for each entry the condReconfigId and the associated fields, as shown in table 5 below:

TABLE 5
CondReconfigToAddModList-r16 ::= SEQUENCE (SIZE (1.. maxNrofCondCells-
r16)) OF CondReconfigToAddMod-r16

| | |
|---|---|
| CondReconfigToAddMod-r16 ::= | SEQUENCE |

| | |
|---|---|
| condReconfigId-r16 | CondReconfigId-r16, |
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING |

| | |
|---|---|
| RRCReconfiguration) | OPTIONAL, -- Cond condReconfigAdd |

```
    ...,
    [[
```

| | |
|---|---|
| condExecutionCondSCG-r17 | OCTET STRING (CONTAINING |

```
CondReconfigExecCondSCG-r17) OPTIONAL -- Need M
    ]],
    [[
```

| | |
|---|---|
| condExecutionCondPSCell-r18 | SEQUENCE (SIZE (1..2)) OF MeasId |

OPTIONAL, -- Cond condReconfigCHO-WithSCG

| | |
|---|---|
| subsequentCondReconfig-r18 | SubsequentCondReconfig-r18 |

OPTIONAL, -- Need M

| | |
|---|---|
| securityCellSetId-r18 | SecurityCellSetId-r18 |

OPTIONAL, -- Need M

| | |
|---|---|
| scpac-ConfigComplete-r18 | ENUMERATED {true} |

```
OPTIONAL -- Cond CPAC
    ]]
  }
```

| | |
|---|---|
| CondReconfigExecCondSCG-r17 ::= | SEQUENCE (SIZE (1..2)) OF MeasId |
| SubsequentCondReconfig-r18 ::= | SEQUENCE { |

condExecutionCondToReleaseList-r18

| | |
|---|---|
| CondExecutionCondToReleaseList-r18 | OPTIONAL, -- Need N |

condExecutionCondToAddModList-r18

| | |
|---|---|
| CondExecutionCondToAddModList-r18 | OPTIONAL, -- Need N |

```
    ...
  }
```

| | | |
|---|---|---|
| CondExecutionCondToAddModList-r18 | ::= | SEQUENCE (SIZE (1.. |

maxNrofCondCells-r16)) OF CondExecutionCondToAddMod-r18

| | |
|---|---|
| CondExecutionCondToAddMod-r18 ::= | SEQUENCE { |
| condReconfigId-r18 | CondReconfigId-r16, |
| condExecutionCond-r18 | SEQUENCE (SIZE (1..2)) OF MeasId |

OPTIONAL, -- Need M

| | |
|---|---|
| condExecutionCondSCG-r18 | OCTET STRING (CONTAINING |

```
CondReconfigExecCondSCG-r17) OPTIONAL, -- Need M
    ...
  }
```

| | | |
|---|---|---|
| CondExecutionCondToReleaseList-r18 | ::= | SEQUENCE (SIZE (1.. |

maxNrofCondCells-r16)) OF CondReconfigId-r16

In table 5:—condExecutionCond (e.g., execution condition of second type for target PSCell) is the execution condition that needs to be fulfilled in order to trigger the execution of a conditional reconfiguration for CHO, CPA, intra-SN CPC without MN involvement, MN initiated inter-SN CPC, or SN initiated intra-SN subsequent CPAC without MN involvement. When configuring 2 triggering events (Meas Ids) for a candidate cell, the network ensures that both refer to the same measObject. For CHO, if the network configures condEventD1 or condEventT1 for a candidate cell, the network configures a second triggering event condEventA3, condEventA4 or condEventA5 for the same candidate cell. The network does not configure both condEventD1 and condEventT1 for the same candidate cell. For CHO in terrestrial networks, the network does not indicate a MeasId associated with condEventA4. For CPA and for MN-initiated inter-SN CPC, the network only indicates MeasId(s) associated with condEventA4. For intra-SN CPC and intra-SN subsequent CPAC, the network only indicates MeasId(s) associated with condEventA3 or condEventA5;
condExecutionCondPSCell (i.e., execution condition of first type for target PSCell) is the execution condition that needs to be fulfilled for the associated PSCell in order to trigger the execution of a conditional reconfiguration for CHO with candidate SCG(s). The Meas Ids refer to the measConfig associated with the MCG. When configuring 2 triggering events (Meas Ids) for a candidate cell, network ensures that both refer to the same measObject. The network only indicates MeasId(s) associated with condEventA4;
condExecutionCondSCG contains execution condition that needs to be fulfilled in order to trigger the execution of a conditional reconfiguration for SN initiated inter-SN CPC, SN initiated inter-SN subsequent CPAC, SN initiated intra-SN subsequent CPAC with MN involvement, or MN initiated inter-SN subsequent CPAC. The Meas Ids refer to the measConfig associated with the SCG. When configuring 2 triggering events (Meas Ids) for a candidate cell, network ensures that both refer to the same measObject. For each condReconfigId, the network always configures either condExecutionCond or condExecutionCondSCG (not both). The network only indicates MeasId(s) associated with condEventA3 or condEventA5;
condRRCReconfig is the RRCReconfiguration message comprising a cell configuration for the corresponding target cell to be applied when the condition(s) are fulfilled. The RRCReconfiguration message contained in condRRCReconfig cannot contain the field conditionalReconfiguration or the field daps-Config;
scpac-ConfigComplete indicates whether the configuration contained in condRRCReconfig for subsequent CPAC is a complete configuration; and
subsequentCondReconfig contains the execution conditions (e.g., execution condition of second type for target PSCell) that need to be fulfilled in order to trigger the execution of a subsequent CPAC. If the field is configured, the configuration of candidate PSCells for subsequent CPAC is supported. The subsequent execution condition is used for conditional reconfiguration evaluation for other candidate cells when the RRCReconfiguration message contained in condRRCReconfig has been applied.

After receiving the list of conditional reconfigurations, the UE may perform conditional reconfiguration evaluation. The UE shall:
1> for each condReconfigId within the VarConditionalReconfig:
2> if the RRCReconfiguration within condRRCReconfig includes the masterCellGroup including the reconfigurationWithSync:
3> if the associated condExecutionCondPSCell is configured:
4> consider the cell which has a physical cell identity matching the value indicated in the ServingCellConfigCommon included in the reconfigurationWithSync within the masterCellGroup in the received condRRCReconfig to be applicable cell; and
4> consider the cell which has a physical cell identity matching the value indicated in the ServingCellConfigCommon included in the reconfigurationWithSync within the secondaryCellGroup within the nr-SCG within the received condRRCReconfig to be applicable cell;
3> else:
4> consider the cell which has a physical cell identity matching the value indicated in the ServingCellConfigCommon included in the reconfigurationWithSync within the masterCellGroup in the received condRRCReconfig to be applicable cell;
2> else if the RRCReconfiguration within condRRCReconfig includes the secondaryCellGroup including the reconfigurationWithSync:
3> if the cell which has a physical cell identity matching the value indicated in the ServingCellConfigCommon included in the reconfigurationWithSync within the secondaryCellGroup within the received condRRCReconfig is not the PSCell:
4> consider the cell to be applicable cell;
2> if condExecutionCondSCG is configured:
3> in the remainder of the procedure, consider each measId indicated in the condExecutionCondSCG as a measId in the VarMeasConfig associated with the SCG measConfig;
2> if the condExecutionCondPSCell is configured:
3> in the remainder of the procedure, consider each measId indicated in the condExecutionCondPSCell as a measId in the VarMeasConfig associated with the MCG measConfig;
2> if condExecutionCond is configured:
3> if it is configured via SRB3 or configured within nr-SCG or within nr-SecondaryCellGroupConfig via SRB1:
4> in the remainder of the procedure, consider each measId indicated in the condExecutionCond as a measId in the VarMeasConfig associated with the SCG measConfig;
3> else:
4> in the remainder of the procedure, consider each measId indicated in the condExecutionCond as a measId in the VarMeasConfig associated with the MCG measConfig;
2> for each measId included in the measIdList within VarMeasConfig indicated in the condExecutionCond, condExecutionCondSCG, or condExecutionCondPSCell associated to condReconfigId:
3> if the condEventId is associated with condEventT1, and if the entry condition applicable for this event associated with the condReconfigId, i.e. the event corresponding with the condEventId(s) of the corresponding condTriggerConfig within VarConditionalReconfig, is fulfilled for the applicable cell; or
3> if the condEventId is associated with condEventD1, and if the entry conditions applicable for this event associated with the condReconfigId, i.e. the event corresponding with the condEventId(s) of the corresponding condTriggerConfig within VarConditionalReconfig, is fulfilled for the applicable cell during the corresponding time ToTrigger defined for this event within the VarConditionalReconfig, or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigId has been modified; or
3> if the condEventId is associated with condEventT1, and if the leaving condition applicable for this event associated with the condReconfigId, i.e. the event corresponding with the condEventId(s) of the corresponding condTriggerConfig within VarConditionalReconfig, is fulfilled for the applicable cell; or
3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cell during the corresponding time ToTrigger defined for this event within the VarConditionalReconfig; or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if condExecutionCondPSCell is not configured:
3> if event(s) associated to all measId(s) within condTriggerConfig for the applicable cell are fulfilled:
4> consider the applicable cell, associated to that condReconfigId, as a triggered cell;
4> initiate the conditional reconfiguration execution;
2> else:
3> if event(s) associated to all measId(s), as indicated in the condExecutionCond and condExecutionCondPSCell, within condTriggerConfig for a target candidate cell within the stored condRRCReconfig are fulfilled:
4> consider the target candidate PCell within the stored condRRCReconfig, associated to that condReconfigId, as a triggered PCell;
4> consider the target candidate PSCell within the stored condRRCReconfig, associated to that condReconfigId, as a triggered PSCell;
4> initiate the conditional reconfiguration execution.

Up to 2 MeasId can be configured for each condReconfigId, if condExecutionCondPSCell is not configured. The conditional reconfiguration event of the 2 MeasId may have the same or different event conditions, triggering quantity, time to trigger, and triggering threshold.

For CHO with candidate SCGs, up to 2 MeasId can be configured for condExecutionCond and up to 2 MeasId can be configured for condExecutionCondPSCell for each condReconfigId.

Upon the conditional reconfiguration execution, the UE shall:
1> if more than one pair of triggered PCell and associated triggered PSCell exist:
2> select one of the triggered PCell(s) and the associated triggered PSCell(s) as the selected cells for conditional reconfiguration execution;
1> else if only one pair of triggered PCell and associated triggered PSCell exists:
2> consider the triggered PCell and the associated triggered PSCell as the selected cells for conditional reconfiguration execution;
1> else if more than one triggered cell exists:
2> select one of the triggered cells as the selected cell for conditional reconfiguration execution;
1> else:
2> consider the triggered cell as the selected cell for conditional reconfiguration execution;
1> for the selected cell(s) of conditional reconfiguration execution:
2> if the subsequentCondReconfig is included in the entry in VarConditionalReconfig containing the RRCReconfiguration message for the selected cell:
3> perform the subsequent CPAC execution;
2> else:
3> apply the stored condRRCReconfig of the selected cell and apply RRCReconfiguration in the condRRCReconfig.

If multiple NR cells are triggered in conditional reconfiguration execution, the UE may select one of them. For example, the UE may consider beams and/or beam quality to select one of the triggered cells for execution.

Upon the conditional reconfiguration execution for subsequent CPAC, the UE shall:
1> if the selected subsequent CPAC candidate configuration is stored in MCG VarConditionalReconfig:
2> release/clear all current dedicated radio configuration except for the following:
the MCG C-RNTI;
the AS security configurations associated with the master key and the secondary key;
for each SRB/DRB in current UE configuration:
keep the associated RLC, PDCP and SDAP entities, their state variables, buffers and timers;
release all fields related to the SRB/DRB configuration except for srb-Identity and drb-Identity,
the UE variables VarConditionalReconfig and VarServingSecurityCellSetID.
2> release/clear all current common radio configuration;
1> else:
2> release/clear all current dedicated radio configuration associated with the SCG except for the following:
the AS security configurations associated with the secondary key;
for each SRB/DRB in current UE configuration which is using the secondary key:
keep the associated RLC, PDCP and SDAP entities, their state variables, buffers and timers;
release all fields related to the SRB/DRB configuration except for srb-Identity and drb-Identity,
the UE variables VarConditionalReconfig. 2> release/clear all current common radio configuration associated with the SCG;
1> use the default values for timers T310, T311 and constants N310, N311 for the cell group for which the subsequent CPAC cell switch procedure is triggered;
1> if the securityCellSetId is included in the entry in VarConditionalReconfig containing the RRCReconfiguration message:
2> if servingSecurityCellSetId is not included within VarServingSecurityCellSetID; or
2> if the value of the securityCellSetId is not equal to the value of servingSecurityCellSetId within VarServingSecurityCellSetID:
3> consider the first sk-Counter value in the sk-CounterList associated with the securityCellSetId within the VarConditionalReconfig as the selected sk-Counter value, and perform security key update procedure;
3> remove the selected sk-Counter value from the sk-CounterList associated with the securityCellSetId within the VarConditionalReconfig;
3> if the current VarServingSecurityCellSetID includes servingSecurityCellSetId:
4> replace the value of servingSecurityCellSetId within VarServingSecurityCellSetID with the value of securityCellSetId associated with the selected cell;
3> else:
4> store the servingSecurityCellSetId within VarServingSecurityCellSetID with the value of securityCellSetId associated with the selected cell;
1> if the selected subsequent CPAC candidate configuration is stored in the SCG VarConditionalReconfig:
2> for each drb-Identity value included in RadioBearerConfig associated with the secondary key (S-KgNB) as indicated by keyToUse that is part of the current UE configuration: 3> trigger the PDCP entity of the AM DRB to perform PDCP data recovery;
3> re-establish the corresponding RLC entity;
1> else:
2> for each drb-Identity value included in RadioBearerConfig that is part of the current UE configuration:
3> if a different keyToUse value is configured; or
3> if a new sk-Counter value has been selected due to the conditional reconfiguration execution for subsequent CPAC:
4> trigger the PDCP entity of the bearer to perform PDCP reestablishment;
3> else:
4> trigger the PDCP entity of the AM DRB to perform PDCP data recovery;
4> re-establish the corresponding RLC entity;
1> if scpac-ConfigComplete is not included within the VarConditionalReconfig for the selected cell:
2> if the subsequent CPAC candidate cell configuration is stored in MCG VarConditionalReconfig:
3> consider scpac-ReferenceConfiguration in MCG VarConditionalReconfig to be the current UE configuration;
2> else:
3> consider scpac-ReferenceConfiguration in SCG VarConditionalReconfig to be the current SCG configuration;

When the UE considers the reference configuration to be the current UE configuration, the UE should store fields and configurations that are part of the reference configuration but should not execute any actions or procedures triggered by the reception of an RRCReconfiguration message.
1> apply the stored condRRCReconfig of the selected cell(s) and apply the RRCReconfiguration in the condRRCReconfig.
1> release the radio bearer(s) and the associated logical channel(s) that are part of the current UE configuration but not part of the subsequent CPAC candidate configuration for the selected cell, or the subsequent CPAC reference configuration (in case the subsequent CPAC candidate configuration does not include scpac-ConfigComplete).

When scpac-ConfigComplete is not included for the selected cell, before a subsequent CPAC execution, a UE implementation may generate and store an RRC reconfiguration message by applying the received subsequent CPAC candidate configuration on top of the subsequent CPAC reference configuration, and the stored RRC reconfiguration message is applied for subsequent CPAC execution.

Meanwhile, UE may be configured with CHO and SCG to be established for dual connectivity (DC) upon CHO execution. UE may be also configured with CPC configuration, where the CPC configuration starts to be applied after the CHO execution and SCG establishment.

Then, the UE may evaluate CHO execution condition. If CHO execution condition is met, UE may perform CHO for PCell handover and then establish SCG to enable DC. After SCG establishment, the UE may start to evaluate CPC execution condition, and if the CPC execution condition is met, the UE may perform SCG change (or, PSCell change/SN change) by establishing a new SCG. During the sequence of the procedural flow, UE has performed CHO once and SCG establishment twice. The first SCG establishment is to establish a SCG1 (i.e., SCG addition) and the second SCG establishment is to replace the SCG1 with a new one, SCG2 (i.e., SCG change). The first SCG establishment for SCG addition could be avoided if the UE can directly establish SCG2 without establishing SCG1.

To enable direct SCG change without performing SCG addition during CHO, UE can be configured to evaluate CHO execution condition as well as CPC execution condition so that CHO and CPC are jointly evaluated. Based on the joint evaluation results, UE can perform CHO only or can perform CHO and CPC jointly. To avoid redundant SCG addition, it is desirable to perform CPC directly without SCG addition if suitable CPC candidate exists while CHO is to be performed. However, since CHO execution condition and CPC execution condition are independent, UE cannot know when or whether CPC execution condition is about to be met. This imposes difficulty to the UE in determining when/whether to perform CHO only or CHO and CPC together in a proper timing.

Therefore, the present disclosure provides various embodiments to handle when/whether to perform CHO only or CHO and CPC together in a proper timing.

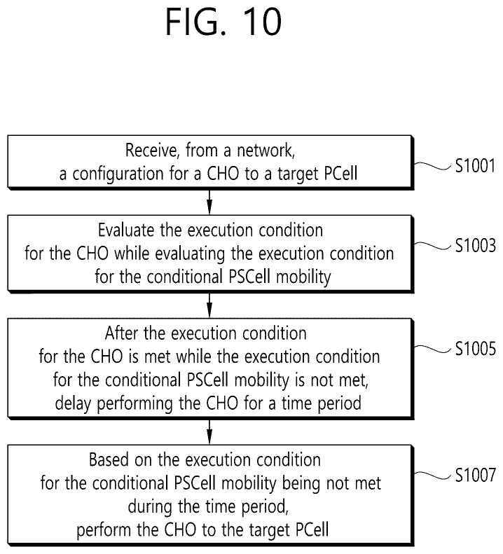

FIG. 10 shows an example of a method performed by a UE according to an embodiment of the present disclosure. The method may also be performed by a wireless device.

Referring to FIG. 10, in step S1001, the UE may receive, from a network, a configuration for a CHO to a target PCell.

The configuration for the CHO may comprise an execution condition for the CHO, and an execution condition for a conditional PSCell mobility to a first target PSCell.

The configuration for the CHO may be related to a configuration for the conditional PSCell mobility.

In step S1003, the UE may evaluate the execution condition for the CHO while evaluating the execution condition for the conditional PSCell mobility.

In step S1005, after the execution condition for the CHO is met while the execution condition for the conditional PSCell mobility is not met, the UE may delay performing the CHO for a time period.

In step S1007, based on the execution condition for the conditional PSCell mobility being not met during the time period, the UE may perform the CHO to the target PCell.

According to various embodiments, based on the execution condition for the CHO is met while an entry condition for the conditional PSCell mobility is met for only a part of a TTT for the execution condition for the PSCell mobility, the UE may determine whether to delay performing the CHO based on an evaluation status of the execution condition for the conditional PSCell mobility. The evaluation status may be determined based on at least one of: a remaining TTT for the execution condition for the conditional PSCell mobility after the execution condition for the CHO is met; or a threshold value.

According to various embodiments, the UE may delay performing the CHO based on the remaining TTT for the execution condition for the conditional PSCell mobility being smaller than the threshold value.

According to various embodiments, the UE may start a timer with a timer value based on the remaining TTT for the execution condition for the conditional PSCell mobility being smaller than the threshold value. The UE may delay performing the CHO while the timer is running.

According to various embodiments, the timer value may be set to the time period, and is greater than the remaining TTT for the execution condition for the conditional PSCell mobility.

According to various embodiments, based on an entry condition for the conditional PSCell mobility being met after an entry condition for the CHO is met, the UE may determine whether to delay performing the CHO based on an evaluation status of the execution condition for the CHO. The evaluation status is determined based on at least one of: a remaining TTT for the execution condition for the CHO after the entry condition for the conditional PSCell mobility is met; or a threshold value.

According to various embodiments, the UE may delay performing the CHO based on the remaining TTT for the execution condition for the CHO being greater than or equal to the threshold value.

According to various embodiments, the UE may start a timer with a timer value based on the remaining TTT for the execution condition for the CHO being greater than or equal to the threshold value. The UE may delay performing the CHO while the timer is running.

According to various embodiments, the timer value may be set to the time period, and is equal to a TTT for the execution condition for the conditional PSCell mobility. The start time of the timer may be equal to the start time of the TTT for the execution condition for the conditional PSCell mobility.

According to various embodiments, the UE may perform the CHO upon an expiry of the timer.

According to various embodiments, the UE may stop the timer based on the entry condition for the conditional PSCell mobility being not met while the timer is running. The UE may perform the CHO upon stopping the timer.

According to various embodiments, the configuration for the CHO may be related to a configuration for an SCG establishment to a second target PSCell. The configuration for the CHO may comprise an RRC reconfiguration for the target PCell. The RRC reconfiguration for the target PCell may comprise the configuration for the SCG establishment to the second target PSCell. To perform the CHO, the UE may apply the RRC reconfiguration for the target PCell and the configuration for the SCG establishment to the second target PSCell, without applying the configuration for the conditional PSCell mobility.

According to various embodiments, the conditional PSCell mobility may comprise at least one of a CPC or a CPA.

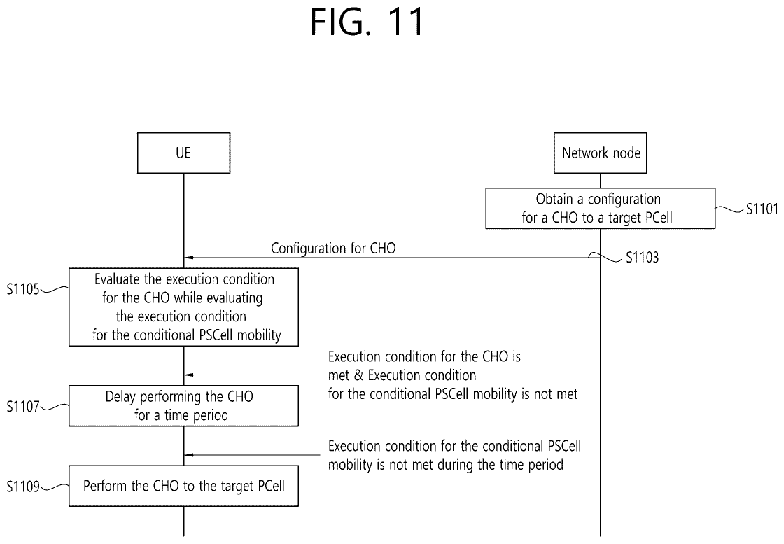

FIG. 11 shows an example of a signal flow between a UE and a network node according to an embodiment of the present disclosure. The network node may comprise a BS.

Referring to FIG. 11, in step S1101, the network node may obtain a configuration for a CHO to a target PCell.

The configuration for the CHO may comprise an execution condition for the CHO, and an execution condition for a conditional PSCell mobility to a first target PSCell. The configuration for the CHO may be related to a configuration for the conditional PSCell mobility.

In step S1103, the network node may transmit, to a UE, the configuration for the CHO to the target PCell.

In step S1105, the UE may evaluate the execution condition for the CHO while evaluating the execution condition for the conditional PSCell mobility.

In step S1107, after the execution condition for the CHO is met while the execution condition for the conditional PSCell mobility is not met, the UE may delay performing the CHO for a time period.

In step S1109, based on the execution condition for the conditional PSCell mobility being not met during the time period, the UE may perform the CHO to the target PCell.

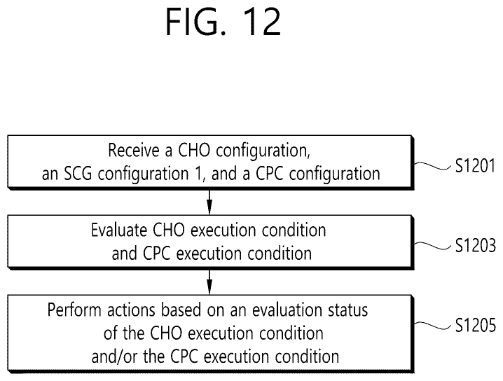

FIG. 12 shows a first example of a method for CHO with concurrent early CPC according to an embodiment of the present disclosure.

Referring to FIG. 12, in step S1201, UE may receive a CHO configuration for target PCell A, an SCG configuration 1 for SCG change/addition for target PSCell B1, and a CPC configuration comprising SCG configuration 2 for target PSCell B2.

The UE may be configured with the CHO configuration for the target PCell A.

The UE may be configured with the SCG configuration 1 for SCG change/addition for the target PSCell B1.

The UE may be configured with the CPC configuration comprising SCG configuration 2 for the target PSCell B2.

The CHO configuration may comprise a CHO execution condition for the target PCell A, and/or a CPC execution condition for the target PSCell B2. The CPC configuration may comprise the CPC execution condition for the target PSCell B2.

In step S1203, the UE may evaluate the CHO execution condition and the CPC execution condition. The UE may simultaneously evaluate the CHO execution condition and the CPC execution condition. The UE may evaluate the CHO execution condition while evaluating the CPC execution condition.

In step S1205, the UE may perform actions based on an evaluation status of the CHO execution condition and/or the CPC execution condition.

For example, if CHO execution condition is met while CPC execution condition is not met, the UE may determine whether to delay CHO execution for some time based on the evaluation status of the CPC execution condition.

If the CPC execution condition is not expected to be met within a short time according to the evaluation status, the UE may immediately perform CHO execution to jointly perform CHO to the PCellA and establish SCG for the PSCell B1 according to the SCG configuration 1.

If the CPC execution condition is expected to be met within a short time according to the evaluation status, the UE may delay CHO execution.

If CHO execution has been delayed but the CPC execution condition is not met within expected time, the UE may immediately perform CHO execution and establish SCG for the PSCell B1 according to the SCG configuration 1.

If CHO execution has been delayed and the CPC execution condition is met within expected time, the UE may immediately perform CHO execution and CPC execution according to the CPC configuration (i.e., establish SCG for the PSCell B2 according to the SCG configuration 2).

For example, UE may be configured with SCG to be used upon CHO but the UE may decide to delay SCG establishment upon CHO execution based on the evaluation status of the CPC execution condition.

If the CPC execution condition is not expected to be met within a short time according to the evaluation status, the UE may immediately perform CHO execution to jointly perform CHO to the PCellA and establish SCG for the PSCell B1 according to the SCG configuration 1 during/after the CHO.

If the CPC execution condition is expected to be met within a short time according to the evaluation status, the UE may immediately perform CHO to the PCellA, but does not immediately establish SCG for the PSCell B1 according to the SCG configuration 1 during/after the CHO. That is, the UE may delay the SCG establishment for the PSCell B1.

If the SCG establishment has been delayed but the CPC execution condition is not met within expected time, the UE may establish SCG (i.e., perform SCG addition) for the PSCell B1 according to the SCG configuration 1.

If CHO execution has been delayed and the CPC execution condition is met within expected time, the UE may perform CPC execution according to the CPC configuration (i.e., establish SCG for the PSCell B2 according to the SCG configuration 2), without SCG establishment/addition for the PSCell B1 according to the SCG configuration 1.

According to various embodiments, an evaluation status of an execution condition may indicate:
whether an entering condition of the execution condition is satisfied;
whether the execution condition is satisfied; and/or
how long the entering condition is satisfied among TTT for the execution condition, or how short a duration is left after a duration the entering condition is satisfied among the TTT.

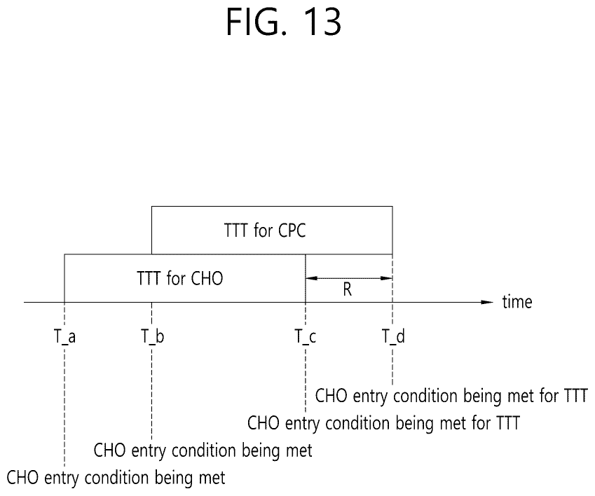

The evaluation status may be defined in various ways, and an example of the evaluation status is illustrated in FIG. 13.

FIG. 13 shows an example of an evaluation status of a CPC execution condition according to an embodiment of the present disclosure.

Referring to FIG. 13, CHO execution condition is met at T_c. Then UE may evaluate R calculated as R=T_d−T_c, where T_d is the expected time for the CPC execution condition to be met for TTT (or, a time when the TTT for the CPC execution condition ends).

If R is less than a threshold (i.e., R<threshold):
the UE may delay CHO execution for some time; or
the UE may perform CHO, but does not immediately establish SCG during/after CHO (i.e., UE may delay SCG establishment).

If R is higher than or equal to the threshold (i.e., R=threshold):
the UE may perform CHO immediately; or
the UE may perform CHO and establish SCG during/after CHO.

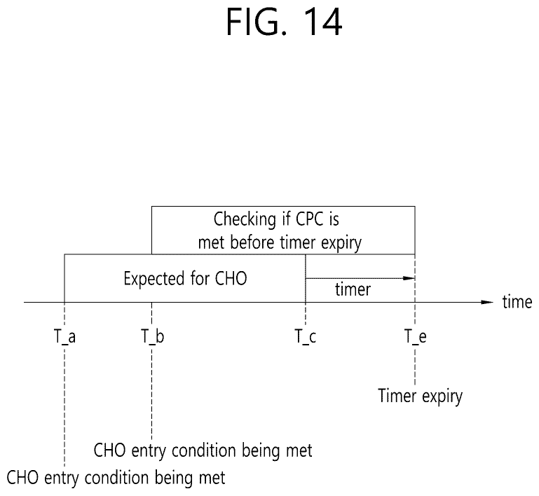

When the CHO and/or SCG establishment is delayed, UE may perform actions as illustrated in FIG. 14.

FIG. 14 shows an example of a timer-based CPC condition evaluation according to an embodiment of the present disclosure.

Referring to FIG. 14, UE may identify that CHO execution condition is met (or, CHO entry condition is met for TTT). Then the UE may check if CPC entry condition for CPC has been met. If the CPC entry condition has been met, the UE may start a timer.

In some implementations, upon starting the timer and/or when the CPC entry condition has been met and/or the CHO execution condition is met, the UE may delay CHO execution. While the timer is running, if the CPC execution condition is met (i.e., the CPC entry condition is met for TTT), the UE may perform CHO and CPC jointly. If the timer expires (i.e., the CPC execution condition is not met while the timer is running), the UE may perform CHO (and SCG establishment related to the CHO), without CPC.

In some implementations, upon starting the timer and/or when the CPC entry condition has been met and/or the CHO execution condition is met, the UE may perform CHO. If the timer is running during/after CHO, UE does not establish SCG (i.e., UE delays SCG establishment). While the timer is running, if the CPC execution condition is met (i.e., the CPC entry condition is met for TTT), the UE may perform CPC without SCG addition/establishment (i.e., establish SCG with CPC candidate cell as PSCell). If the timer expiries, the UE may perform SCG addition/establishment (i.e., establish SCG according to the SCG configured for CHO).

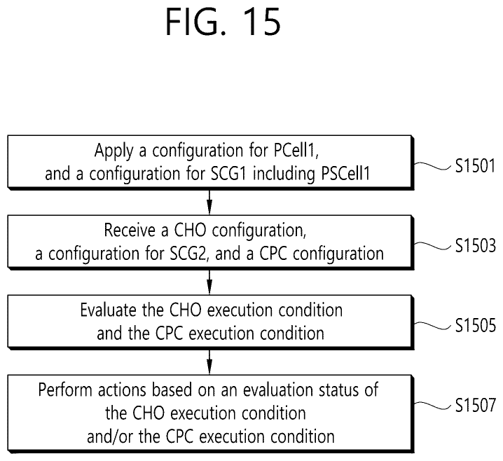

FIG. 15 shows a second example of a method for CHO with concurrent early CPC according to an embodiment of the present disclosure.

Referring to FIG. 15, in step S1501, UE may apply a configuration for PCell1, and a configuration for SCG1 including PSCell1. That is, the UE may be configured with the PCell1, and configured with the SCG1 including the PSCell1.

In step S1503, the UE may receive a CHO configuration, a configuration for SCG2, and a CPC configuration.

The UE may be configured with the CHO configuration, where the CHO configuration may include a configuration for PCell2 which is a CHO candidate cell, MCG configuration of the CHO candidate cell, and/or CHO execution condition for the CHO candidate cell.

The UE may be also configured with the configuration for the SCG2 that is to be established upon CHO execution to the CHO candidate cell, where the configuration for the SCG2 may include SpCell configuration of a PSCell2 related to the SCG2.

The UE may be also configured with the CPC configuration, where the CPC configuration may include a configuration for PSCell3 which is a CPC candidate cell, a configuration for SCG3 related to the CPC candidate cell, and/or a CPC execution condition for the CPC candidate cell.

In step S1505, the UE may evaluate the CHO execution condition and the CPC execution condition. The UE may simultaneously evaluate the CHO execution condition and the CPC execution condition. The UE may evaluate the CHO execution condition while evaluating the CPC execution condition.

In step S1507, the UE may perform actions based on an evaluation status of the CHO execution condition and/or the CPC execution condition.

If entry condition for the CHO execution condition is satisfied, UE may start TTT for the CHO execution condition.

In some implementations, if entry condition for the CPC execution condition is satisfied, UE may start TTT for the CPC execution condition.

Upon expiry of TTT for the CHO execution condition (i.e., the entry condition of the CHO execution condition is met for TTT):
If remaining TTT for the CPC execution condition is smaller than a threshold, the UE may delay CHO execution, and start a first timer. The first timer value may be set to the remaining TTT value, or the remaining TTT value+non-negative value.
Else (i.e., the remaining TTT for the CPC execution condition is greater than or equal to the threshold), the UE may perform CHO execution to the CHO candidate cell PCell2, (hence the PCell2 becomes serving PCell), establish MCG of the CHO candidate cell, and establish SCG in accordance with the configuration for the SCG2 (hence the PSCell2 becomes serving PSCell).

In some implementations, if entry condition for the CPC execution condition is satisfied:
If the remaining time for TTT for the CHO execution condition is smaller than a threshold, the UE does not start the TTT for the CPC execution condition; and/or
If the remaining time for the TTT for the CHO execution condition is not smaller than the threshold (i.e., greater than or equal to the threshold), the UE may start the TTT for the CPC execution condition, and start a second timer. The second timer value may be set to the TTT for the CPC execution condition, or the TTT for the CPC execution condition+non-negative value.

Upon expiry of the TTT for CHO the execution condition (i.e., the entry condition of the CHO execution condition is met for TTT), if the TTT for CPC is running (or if the second timer is running), the UE may delay CHO execution while the second timer is running.

If the CPC entry condition is met while the first timer/second timer is running, or the CPC execution condition is met (i.e., the CPC entry condition is met for TTT) while the first timer/second timer is running, the UE may perform CHO execution, and CPC execution according to the CPC configuration (i.e., establish the SCG3 in accordance with the configuration for the SCG3 related to the PSCell3, hence the PSCell3 becomes a serving PSCell).

Upon expiry of the first timer/second timer (i.e., the CPC execution condition is not met while the first timer/second timer is running), the UE may perform CHO execution to the CHO candidate cell (hence PCell2 becomes serving PCell), establish MCG of the CHO candidate cell, and establish SCG2 in accordance with the configuration for the SCG2 (hence PSCell2 becomes serving PSCell).

While the first timer/second timer is running, if the CPC execution condition/CPC entry condition is no longer met, UE may stop the first timer/second timer. Upon stopping of the first timer/second timer, the UE may perform CHO execution to the CHO candidate cell (hence PCell2 becomes serving PCell), establish MCG of the CHO candidate cell, and establish SCG2 in accordance with the configuration for the SCG2 (hence PSCell2 becomes serving PSCell).

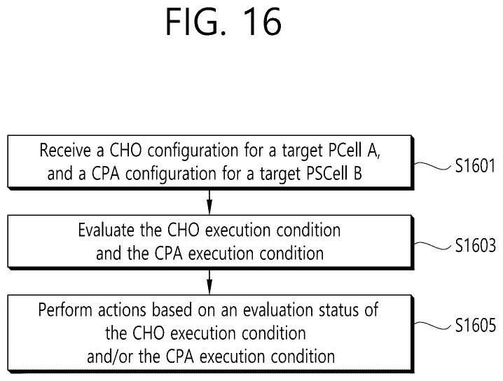

Further, it is also possible for UE to delay CHO execution based on CPA evaluation status, as shown in FIG. 16.

FIG. 16 shows an example of a method for CHO with concurrent early CPA according to an embodiment of the present disclosure.

Referring to FIG. 16, in step S1601, UE may receive a CHO configuration for a target PCell A, and a CPA configuration for a target PSCell B.

The UE may be configured with the CHO configuration including a CHO execution condition for the target Pcell A. The UE may be configured with the CPA configuration including SCG configuration and CPA execution condition for the target PSCell B.

In step S1603, the UE may evaluate the CHO execution condition and the CPA execution condition. The UE may simultaneously evaluate the CHO execution condition and the CPA execution condition. The UE may evaluate the CHO execution condition while evaluating the CPA execution condition.

In step S1605, the UE may perform actions based on an evaluation status of the CHO execution condition and/or the CPA execution condition.

For example, if the CHO execution condition is met while the CPA execution condition is not met, the UE may determine whether to delay CHO execution for some time based on an evaluation status of the CPA execution condition.

If the CPA execution condition is not expected to be met within a short time, the UE may immediately perform CHO execution to PCell A.

If the CPC execution condition is expected to be met within a short time, the UE may delay CHO execution.

If the CHO execution has been delayed but the CPC execution condition is not met within expected time, the UE may immediately perform the CHO execution.

If the CHO execution has been delayed and the CPC execution condition is met within expected time, the UE may immediately perform CHO execution and CPA execution (i.e., establish SCG for the PSCell B according to the SCG configuration).

Furthermore, the method in perspective of the UE described in the present disclosure (e.g., in FIG. 10) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: receiving, from a network, a configuration for a conditional handover (CHO) to a target primary cell (PCell), wherein the configuration for the CHO comprises an execution condition for the CHO, and an execution condition for a conditional primary secondary cell (PSCell) mobility to a first target PSCell, and wherein the configuration for the CHO is related to a configuration for the conditional PSCell mobility; evaluating the execution condition for the CHO while evaluating the execution condition for the conditional PSCell mobility; after the execution condition for the CHO is met while the execution condition for the conditional PSCell mobility is not met, delaying performing the CHO for a time period; and based on the execution condition for the conditional PSCell mobility being not met during the time period, performing the CHO to the target PCell.

Furthermore, the method in perspective of the UE described in the present disclosure (e.g., in FIG. 10) may be performed by a software code 105 stored in the memory 104 included in the first wireless device 100 shown in FIG. 2.

More specifically, at least one computer readable medium (CRM) stores instructions that, based on being executed by at least one processor, perform operations comprising: receiving, from a network, a configuration for a conditional handover (CHO) to a target primary cell (PCell), wherein the configuration for the CHO comprises an execution condition for the CHO, and an execution condition for a conditional primary secondary cell (PSCell) mobility to a first target PSCell, and wherein the configuration for the CHO is related to a configuration for the conditional PSCell mobility; evaluating the execution condition for the CHO while evaluating the execution condition for the conditional PSCell mobility; after the execution condition for the CHO is met while the execution condition for the conditional PSCell mobility is not met, delaying performing the CHO for a time period; and based on the execution condition for the conditional PSCell mobility being not met during the time period, performing the CHO to the target PCell.

Furthermore, the method in perspective of the UE described in the present disclosure (e.g., in FIG. 10) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: receiving, from a network, a configuration for a conditional handover (CHO) to a target primary cell (PCell), wherein the configuration for the CHO comprises an execution condition for the CHO, and an execution condition for a conditional primary secondary cell (PSCell) mobility to a first target PSCell, and wherein the configuration for the CHO is related to a configuration for the conditional PSCell mobility; evaluating the execution condition for the CHO while evaluating the execution condition for the conditional PSCell mobility; after the execution condition for the CHO is met while the execution condition for the conditional PSCell mobility is not met, delaying performing the CHO for a time period; and based on the execution condition for the conditional PSCell mobility being not met during the time period, performing the CHO to the target PCell.

Furthermore, the method in perspective of a network node described in the present disclosure (e.g., in FIG. 11) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: obtaining a configuration for a conditional handover (CHO) to a target primary cell (PCell), wherein the configuration for the CHO comprises an execution condition for the CHO, and an execution condition for a conditional primary secondary cell (PSCell) mobility to a first target PSCell, and wherein the configuration for the CHO is related to a configuration for the conditional PSCell mobility; and transmitting, to a user equipment (UE), the configuration for the CHO to the target PCell, wherein the UE is configured to perform operations comprising: evaluating the execution condition for the CHO while evaluating the execution condition for the conditional PSCell mobility; after the execution condition for the CHO is met while the execution condition for the conditional PSCell mobility is not met, delaying performing the CHO for a time period; and based on the execution condition for the conditional PSCell mobility being not met during the time period, performing the CHO to the target PCell.

The present disclosure may have various advantageous effects.

For example, unnecessary signaling and/or interruption can be prevented when executing a conditional mobility based on simultaneous evaluation of conditional handover (CHO) condition and conditional primary secondary cell (PSCell) mobility condition.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising:
receiving, from a network, a configuration for a conditional handover (CHO) to a target primary cell (PCell),
wherein the configuration for the CHO comprises an execution condition for the CHO, and an execution condition for a conditional primary secondary cell (PSCell) mobility to a first target PSCell, and
wherein the configuration for the CHO is related to a configuration for the conditional PSCell mobility;
evaluating the execution condition for the CHO while evaluating the execution condition for the conditional PSCell mobility;
after the execution condition for the CHO is met while the execution condition for the conditional PSCell mobility is not met, delaying performing the CHO for a time period; and
based on the execution condition for the conditional PSCell mobility being not met during the time period, performing the CHO to the target PCell.

2. The method of claim 1, further comprising:
based on the execution condition for the CHO is met while an entry condition for the conditional PSCell mobility is met for only a part of a time-to-trigger (TTT) for the execution condition for the PSCell mobility, determining whether to delay performing the CHO based on an evaluation status of the execution condition for the conditional PSCell mobility,
wherein the evaluation status is determined based on at least one of:
a remaining TTT for the execution condition for the conditional PSCell mobility after the execution condition for the CHO is met; or
a threshold value.

3. The method of claim 2, wherein the delaying of performing the CHO comprises delaying performing the CHO based on the remaining TTT for the execution condition for the conditional PSCell mobility being smaller than the threshold value.

4. The method of claim 2, further comprising:
starting a timer with a timer value based on the remaining TTT for the execution condition for the conditional PSCell mobility being smaller than the threshold value,
wherein the delaying of performing the CHO comprises delaying performing the CHO while the timer is running.

5. The method of claim 4, wherein the timer value is set to the time period, and is greater than the remaining TTT for the execution condition for the conditional PSCell mobility.

6. The method of claim 1, further comprising:
based on an entry condition for the conditional PSCell mobility being met after an entry condition for the CHO is met, determining whether to delay performing the CHO based on an evaluation status of the execution condition for the CHO,
wherein the evaluation status is determined based on at least one of:
a remaining time-to-trigger (TTT) for the execution condition for the CHO after the entry condition for the conditional PSCell mobility is met; or
a threshold value.

7. The method of claim 6, wherein the delaying of performing the CHO comprises delaying performing the CHO based on the remaining TTT for the execution condition for the CHO being greater than or equal to the threshold value.

8. The method of claim 6, further comprising:
starting a timer with a timer value based on the remaining TTT for the execution condition for the CHO being greater than or equal to the threshold value,
wherein the delaying of performing the CHO comprises delaying performing the CHO while the timer is running.

9. The method of claim 8, wherein the timer value is set to the time period, and is equal to a TTT for the execution condition for the conditional PSCell mobility, and
wherein a start time of the timer is equal to a start time of the TTT for the execution condition for the conditional PSCell mobility.

10. The method of claim 4, wherein the performing of the CHO comprises performing the CHO upon:
an expiry of the timer; or
the timer being stopped, and
wherein the timer is stopped stopping the timer based on the entry condition for the conditional PSCell mobility being not met while the timer is running.

11. The method of claim 1, wherein the configuration for the CHO is related to a configuration for a secondary cell group (SCG) establishment to a second target PSCell,
wherein the configuration for the CHO comprises a radio resource control (RRC) reconfiguration for the target PCell,
wherein the RRC reconfiguration for the target PCell comprises the configuration for the SCG establishment to the second target PSCell, and
wherein the performing of the CHO comprises applying the RRC reconfiguration for the target PCell and the configuration for the SCG establishment to the second target PSCell, without applying the configuration for the conditional PSCell mobility.

12. The method of claim 1, wherein the conditional PSCell mobility comprises at least one of a conditional PSCell change (CPC), or a conditional PSCell addition (CPA).

13. The method of claim 1, wherein the method is performed by a user equipment (UE) in communication with at least one of a mobile device, a network, or autonomous vehicles.

14. A user equipment (UE) comprising:
at least one transceiver;
at least one processor; and
at least one memory operatively coupled to the at least one processor and storing instructions that, based on being executed by the at least one processor, perform operations comprising:
receiving, from a network, a configuration for a conditional handover (CHO) to a target primary cell (PCell),
wherein the configuration for the CHO comprises an execution condition for the CHO, and an execution condition for a conditional primary secondary cell (PSCell) mobility to a first target PSCell, and
wherein the configuration for the CHO is related to a configuration for the conditional PSCell mobility;
evaluating the execution condition for the CHO while evaluating the execution condition for the conditional PSCell mobility;
after the execution condition for the CHO is met while the execution condition for the conditional PSCell mobility is not met, delaying performing the CHO for a time period; and
based on the execution condition for the conditional PSCell mobility being not met during the time period, performing the CHO to the target PCell.

15. (canceled)

16. A network node comprising:
at least one transceiver;
at least one processor; and
at least one memory operatively coupled to the at least one processor and storing instructions that, based on being executed by the at least one processor, perform operations comprising:
obtaining a configuration for a conditional handover (CHO) to a target primary cell (PCell),
wherein the configuration for the CHO comprises an execution condition for the CHO, and an execution condition for a conditional primary secondary cell (PSCell) mobility to a first target PSCell, and
wherein the configuration for the CHO is related to a configuration for the conditional PSCell mobility; and
transmitting, to a user equipment (UE), the configuration for the CHO to the target PCell,
wherein the UE is configured to perform operations comprising:
evaluating the execution condition for the CHO while evaluating the execution condition for the conditional PSCell mobility;
after the execution condition for the CHO is met while the execution condition for the conditional PSCell mobility is not met, delaying performing the CHO for a time period; and
based on the execution condition for the conditional PSCell mobility being not met during the time period, performing the CHO to the target PCell.

17-20. (canceled)
